(19) United States
(12) Patent Application Publication
(10) Pub. No.: US 2025/0190145 A1
(43) Pub. Date: Jun. 12, 2025

(54) METHOD AND APPARATUS FOR IN-MEMORY COMPUTATION

(71) Applicant: SAMSUNG ELECTRONICS CO., LTD., SUWON-SI (KR)

(72) Inventors: YOONAH PAIK, SUWON-SI (KR); SANGHOON CHA, SUWON-SI (KR)

(21) Appl. No.: 18/971,642

(22) Filed: Dec. 6, 2024

(30) Foreign Application Priority Data
Dec. 6, 2023 (KR) 10-2023-0175705

(51) Int. Cl. G06F 3/06

(52) U.S. Cl. CPC G06F 3/0659; G06F 3/0604; G06F 3/0653; G06F 3/0673

(57) ABSTRACT

A method of controlling a memory module for a processing in-memory (PIM) computation includes monitoring, based on a first command and an address, an open state of a PIM row of a PIM computation bank in the memory module corresponding to the address, generating a PIM computation command signal when it is determined as a result of the monitoring that a PIM row of each of PIM computation banks included in the memory module is in an open state, and controlling the memory module so that a second command received while the PIM computation command signal is generated is processed using a PIM computation.

### CROSS-REFERENCE TO RELATED APPLICATION

This patent application claims priority under 35 USC § 119(a) to Korean Patent Application No. 10-2023-0175705 filed on Dec. 6, 2023, in the Korean Intellectual Property Office, the entire disclosure of which is incorporated by reference in its entirety herein.

### 1. TECHNICAL FIELD

One or more embodiments below are directed to a method and apparatus for performing an in-memory computation.

### 2. DISCUSSION OF RELATED ART

In a von Neumann architecture computer system, a memory device is separate in function from a processor that performs operational tasks. Accordingly, in a system that requires operations on a large amount of data such as a neural network, big data and Internet of Things (IoT), a bottleneck may frequently occur between the memory device and the processor. A processing in-memory device that combines a function of a memory with a function of a processor that performs operational tasks may reduce this bottleneck.

### SUMMARY

At least one embodiment provides a method of controlling a memory module in such a way that processing-in-memory (PIM) computations and general memory operations may be processed without changing the mode of the memory module or modifying a memory controller.

At least one embodiment provides a memory device that processes PIM computations and general memory operations without changing the mode of the memory module or modifying the memory controller.

According to an aspect, there is provided a method of controlling a memory module for a processing in-memory (PIM) computation including: monitoring, based on a first command and an address, an open state of a PIM row of a PIM computation bank in the memory module corresponding to the address, generating a PIM computation command signal when it is determined as a result of the monitoring that a PIM row of each of PIM computation banks included in the memory module is in the open state, and controlling the memory module so that a second command received while the PIM computation command signal is generated is processed using a PIM computation.

The monitoring of the open state may include monitoring the open state of the PIM row of the PIM computation bank in the memory module corresponding to the address when the first command is an activation command and the address is within a PIM operator address range.

The monitoring of the open state may include updating a count value stored in a register in accordance with the PIM computation bank for every clock cycle and determining that the PIM row of the PIM computation bank in the memory module corresponding to the address is in the open state, based on the count value.

The method further includes setting the count value corresponding to a first PIM computation bank to a value indicating a time until a PIM row of the first PIM computation bank is opened after an activation command corresponding to an address of the first PIM computation bank is processed.

The method may further include storing a number of times that PIM computations need to be processed in the memory module, wherein the second command is processed using the PIM computation when the number of times is non-zero.

The method may further include stopping generation of the PIM computation command signal based on whether a number of times a PIM computation is performed in the memory module reaches a threshold number.

The controlling of the memory module may include controlling the memory module so that a read command or a write command received while the PIM computation command signal is generated is processed using a PIM computation.

The method may further include stopping generation of the PIM computation command signal based on receipt of a precharge command.

The method may further include initializing, based on receipt of the precharge command, the count value corresponding with a PIM computation bank of an address corresponding to the precharge command.

The method may further include controlling the memory module so that a command received after stopping generation of the PIM computation command signal is processed using a normal memory operation.

The PIM computation banks in the memory module may be classified into groups including a first group and a second group.

The generating of the PIM computation command signal may include generating a PIM computation command signal corresponding to the first group when it is determined as a result of the monitoring that a PIM row of each of PIM computation banks included in the first group is in an open state.

The controlling of the memory module may include controlling the memory module so that a command received corresponding to a PIM computation bank included in the first group is processed using a PIM computation.

According to an aspect, there is provided a memory device for performing a processing in-memory (PIM) computation including a memory module and a processor. The memory module includes at least one of a plurality of PIM computation banks. The processor is configured to control the memory module. The processor is configured to monitor, based on a first command and an address, an open state of a PIM row of one of the PIM computation banks in the memory module corresponding to the address, generate a PIM computation command signal when it is determined as a result of the monitor that a PIM row of each of the PIM computation banks is in the open state, and control the memory module so that a second command received while the PIM computation command signal is generated is processed using a PIM computation.

In the monitor of the open state, the processor may be configured to monitor the open state of the PIM row of the PIM computation bank in the memory module corresponding to the address when a received command is an activation command and the address is within a PIM operator address range.

In the monitor of the open state, the processor may be configured to update a count value stored in a register in accordance with the PIM computation bank for every clock cycle and determine that the PIM row of the PIM computation bank in the memory module corresponding to the address is in an open state, based on the count value.

The processor may be configured to store a number of times that PIM computations need to be processed in the memory module, where the second command may be processed using the PIM computation when the number of times is non-zero.

The processor may be configured to stop generation of the PIM computation command signal based on whether a number of times a PIM computation is performed in the memory module reaches a threshold number.

In the control of the memory module, the processor may be configured to control the memory module so that a read command or a write command received while the PIM computation command signal is generated is processed using a PIM computation.

The processor may be configured to stop generation of the PIM computation command signal based on receipt of a precharge command and initialize, based on receipt of the precharge command, a count value stored in a register in accordance with a PIM computation bank of an address corresponding to the precharge command.

The processor may be configured to control the memory module so that a command received after stopping generation of the PIM computation command signal is processed using a normal memory operation.

According to an aspect, there is provided a device to perform a processing in-memory (PIM) computation including a processor. The processor is configured to monitor, based on a command and an address, an open state of a PIM row of a PIM computation bank in the memory module corresponding to the address, generate a PIM computation command signal when it is determined as a result of the monitor that a PIM row of each of PIM computation banks included in the memory module is in an open state, and control the memory module so that a command received while the PIM computation command signal is generated is processed using a PIM computation.

According to an aspect, there is provided a PIM memory system including a memory device and a control circuit. The memory device includes memory banks and a PIM engine. The control circuit is configured to maintain a count value for each of the memory banks, decrement the count value of a memory bank among the memory banks every clock signal upon receiving an activation command and an address within an PIM range for the memory bank and determine whether each count value has reached a pre-determined value. The control circuit controls the memory device to enable the PIM engine to perform a PIM computation in response to an access command (e.g., a read or write command) when it is determined that each count value has reached the pre-determined value and otherwise controls the memory device to perform a memory operation in response to the access command. The memory device may further include a register storing the count value for each of the memory banks. In an embodiment, at least one of the memory banks stores a PIM operator and the PIM engine executes the PIM operator on data stored in the memory device to perform the PIM computation.

### BRIEF DESCRIPTION OF THE DRAWINGS

These and/or other aspects and features of the inventive concept will become apparent and more readily appreciated from the following description of embodiments, taken in conjunction with the accompanying drawings of which:

FIG. 1 is a diagram illustrating a configuration of a memory system for an in-memory computation, according to an embodiment;

FIG. 2 is a flowchart illustrating a method of controlling a memory module for an in-memory computation, according to an embodiment;

FIGS. 3A and 3B are diagrams illustrating structures of a processing-in-memory (PIM) computation command signal generation circuit, according to an embodiment;

FIG. 4 is a flowchart illustrating an operation of a memory device according to an embodiment;

FIG. 5 is a diagram illustrating a command processed in a PIM computation bank according to an embodiment; and

FIG. 6 is a diagram illustrating a configuration of a memory device for an in-memory computation, according to an embodiment.

### DETAILED DESCRIPTION

The following description is provided as examples of certain embodiments of the inventive concept that may be implemented. However, the inventive concept is not limited to these embodiments since various alterations and modifications may be made to the examples. Thus, the embodiments are understood to include all changes, equivalents, and replacements within the technical scope of this description. With regard to the description of the drawings, like reference numerals may be used for like or related components. The singular form of a noun corresponding to an item may include one or more of the above items, unless the relevant context clearly indicates otherwise. As used herein, each of “at least one of A and B,” “at least one of A or B,” “at least one of A, B, and C,” “at least one of A, B, or C,” and the like may include any one of the items listed together in the corresponding one of the phrases, or all possible combinations thereof. Terms such as “first,” “second,” and the like may be used only to distinguish one component from another and may not limit the components in other aspects (e.g., importance, order, etc.). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

The singular forms “a,” “an,” and “the” are intended to include the plural forms as well, unless the context clearly indicates otherwise.

Hereinafter, the examples are described in detail with reference to the accompanying drawings. When describing the examples with reference to the accompanying drawings, like reference numerals refer to like components and a repeated description related thereto is omitted.

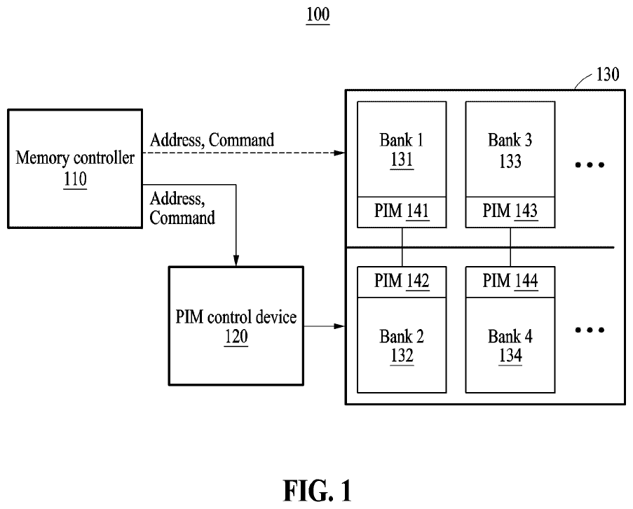

FIG. 1 is a diagram illustrating a configuration of a memory system for an in-memory computation, according to an embodiment.

Referring to FIG. 1, a memory system 100 may include a memory controller 110 (e.g., a first control circuit), a processing in-memory (PIM) control device 120 (e.g., a second control circuit), and a memory module 130.

The memory controller 110 may transmit a command and an address to the PIM control device 120. The memory controller 110 may be linked to a host that generates a signal of the command and the address or may be included in the host. For example, the host may be a computer and send a signal representing the command and the address to the memory controller 110. For example, the memory controller 110 may also transmit the command and the address to the memory module 130. In other words, the memory module 130 may receive the command and the address transmitted from the memory controller 110 through the PIM control device 120 or may receive the command and the address from the memory controller 110.

The memory module 130 may be dynamic random-access memory (DRAM). However, embodiments are not limited thereto. For example, the memory module 130 may be another random-access memory (RAM) such as static RAM (SRAM), magnetic RAM (MRAM), phase-change RAM (PRAM), ferroelectric RAM (FRAM), resistive RAM (RRAM), and the like.

The memory module 130 may include one or more memory banks. Each of the memory banks may include a plurality of memory cells connected to a plurality of word lines WLs. The word lines WLs may be respectively connected to the plurality of memory cells. A memory cell array may include the plurality of memory cells (not shown) arranged in row and column directions. Each of the plurality of memory cells may be connected to one word line WL among the plurality of word lines WLs and one bit line BL among a plurality of bit lines BLs. One or more word lines among the plurality of word lines WLs may be selected as an access target based on a row address received from the memory controller 110. The one or more word lines selected among the plurality of word lines WLs as an access target may be activated.

At least a portion of the memory banks may be set as a bank for performing a PIM computation. The bank for performing a PIM computation may be referred to as a PIM computation bank. For example, a first bank 131, a second bank 132, a third bank 133, and a fourth bank 134 of the memory module 130 may be set as a PIM computation bank. The first bank 131, the second bank 132, the third bank 133, and the fourth bank 134 corresponding to the PIM computation bank may each include a row that stores a PIM operator. The PIM operator may be one or more specific computation operations or tasks. The row that stores the PIM operator may be referred to as a PIM row. In an embodiment, the PIM row in the PIM computation bank is not a dedicated row or a physically fixed row. For example, one or more rows among rows included in the PIM computation bank may be determined to be the PIM row according to logic.

The first bank 131, the second bank 132, the third bank 133, and the fourth bank 134 corresponding to the PIM computation bank may include PIM engines 141, 142, 143, and 144 for a PIM computation, respectively. Data stored in the PIM row in each PIM computation bank may be stored in a row buffer within the PIM computation bank and may be transmitted from the row buffer to the PIM engines 141, 142, 143, and 144 in the PIM computation bank so that a PIM computation may be performed by the PIM engines 141, 142, 143, and 144. The PIM engines 141, 142, 143, and 144 may include a processor or a logic circuit capable of performing a computation on data stored in memory.

The PIM control device 120 may receive the signal of the command and the address as an input signal from the memory controller 110, classify the input signal into one of a PIM computation request and a general memory request, and output a signal for controlling the memory module 130 according to the classification. An operation of the PIM control device 120 is described in detail below.

The PIM control device 120 may include a register that stores a PIM operator address range. The PIM operator address range may include a lower address and an upper address corresponding to one or more PIM operators. Addresses of the memory module 130 storing the PIM operator may be stored in the register of the PIM control device 120. The PIM control device 120 may determine whether an address indicated by the input signal is within the PIM operator address range stored in the register. For example, the command may correspond to a PIM computation request when the address is within the PIM operator address range PIM and corresponds to a general memory request when the address is outside the PIM operator address range PIM.

The PIM control device 120 may include a register that stores a row access strobe (RAS) to column access strobe (CAS) delay (RCD) count value corresponding to each of the PIM computation banks. For example, the RCD count value corresponding to each of the PIM computation banks may be initialized to a value (e.g., a number of clock cycles) indicating the time from when an activation command ACT corresponding to an address of a PIM computation bank is processed until the PIM row of the PIM computation bank is opened. In an embodiment, the RCD count value decreases by “1” for every clock cycle after the activation command ACT corresponding to the address of the PIM computation bank is processed. When the RCD count value stored in the register becomes 0, the PIM row of the corresponding PIM computation bank may be determined to be in an open state or opened.

The PIM control device 120 may include a register that stores a number of times that PIM computations need to be processed in the memory module 130. Each time the memory module 130 processes a received command using a PIM computation, the number of times of PIM computations stored in the register may decrease by “1.” Alternatively, the PIM control device 120 may include a register that stores a number of times that PIM computations are processed in the memory module 130. Each time the memory module 130 processes a received command for a PIM computation, the number of times that PIM computations are processed in the memory module 130 stored in the register may increase by “1.”

The PIM control device 120 may include a circuit that generates a PIM computation command signal for controlling the memory module 130, based on a register and an input signal. The PIM control device 120 may control the memory module 130 so that a command received while the PIM computation command signal is being generated may be processed using a PIM computation.

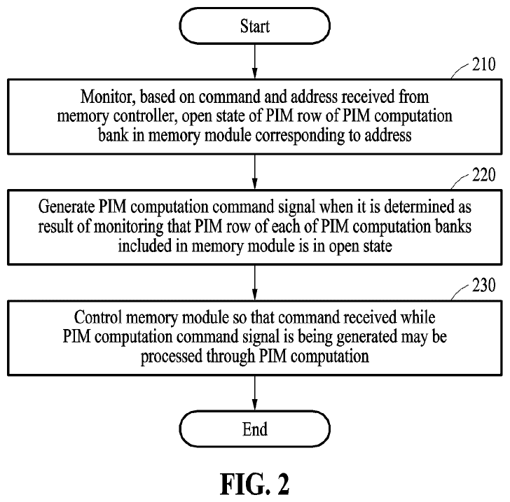

FIG. 2 is a flowchart illustrating a method of controlling a memory module for an in-memory computation, according to an embodiment.

For example, the method of controlling a memory module for an in-memory computation may be performed by at least one processor or logic circuit of the PIM control device 120 of FIG. 1.

Referring to FIG. 2, the method of controlling the memory module for an in-memory computation includes operation 210 of monitoring, based on a command and an address received from a memory controller, an open state of a PIM row of a PIM computation bank in the memory module corresponding to the address. The monitoring may determine when the PIM row has entered the open state.

The operation 210 of monitoring the open state of the PIM row of the PIM computation bank may include monitoring the open state of the PIM row of the PIM computation bank corresponding to the address, when the received command is an activation command ACT and the received address is within a PIM operator address range. When an RCD time elapses after the activation command targeting the PIM computation bank is processed, the PIM row of the corresponding PIM computation bank may be opened or enter an open state. To monitor whether the RCD time has elapsed after the activation command targeting the PIM computation bank is processed, a value regarding the RCD time corresponding to each PIM computation bank may be stored in a register. For example, RCD time may be determined from the value. The activation command targeting the PIM computation bank may refer to an activation command received along with the address corresponding to the PIM computation bank.

The operation 210 of monitoring the open state of the PIM row of the PIM computation bank may include updating an RCD count value stored in a register in accordance with the PIM computation bank for every clock cycle and determining, based on the RCD count value, whether the PIM row of the PIM computation bank corresponding to the address is in an open state.

An RCD count value, which is stored in the register, corresponding to a first PIM computation bank may be set to a value indicating the time until a PIM row of the first PIM computation bank is opened after an activation command corresponding to the address of the first PIM computation bank is processed. For example, when it takes 14 clock cycles until the PIM row of the first PIM computation bank is opened after the activation command corresponding to the address of the first PIM computation bank is processed, the RCD count value, which is stored in the register, corresponding to the first PIM computation bank may be set to “14.” For example, the RCD count value could indicate a certain number of clock cycles. When an activation command targeting the first PIM computation bank is received, the RCD count value stored in the register in accordance with the first PIM computation bank may decrease by “1” per clock cycle. When the RCD count value stored in accordance with the first PIM computation bank becomes “0,” it means that the time until the PIM row of the first PIM computation bank is opened after the activation command targeting the first PIM computation bank is processed has elapsed and thus, the PIM row of the first PIM computation bank may be determined to be in an open state.

The method of controlling the memory module for the in-memory computation of FIG. 2 includes an operation 220 of generating a PIM computation command signal when it is determined as a result of the monitoring that a PIM row of each of the PIM computation banks included in the memory module is in an open state. For example, generating a PIM computation command signal may indicate setting a value of the PIM computation command signal to “1.”

For example, when all RCD count values, which are stored in the register, corresponding to the PIM computation banks become “0,” PIM rows of all PIM computation banks included in the memory module may be determined to be in an open state. When the PIM rows of all the PIM computation banks included in the memory module are determined to be in an open state, a PIM computation command signal may be generated.

Monitoring and generation of a PIM computation command signal may be performed for each group of PIM computation banks. The PIM computation banks in the memory module may be classified into groups including a first group and a second group. For example, the first PIM computation bank may be classified as the first group, and the second PIM computation bank may be classified as the second group. When the PIM rows of all PIM computation banks corresponding to a same group are determined to be in an open state, a PIM computation command signal corresponding to the group may be generated. For example, when PIM rows of all PIM computation banks corresponding to the first group in the memory module are determined to be in an open state, a PIM computation command signal corresponding to the first group may be generated. Even when PIM rows of PIM computation banks not corresponding to the first group in the memory module are not in an open state, when the PIM rows of all the PIM computation banks corresponding to the first group are determined to be in an open state, the PIM computation command signal correspond to the first group may be generated.

The method of controlling the memory module for the in-memory computation of FIG. 2 includes an operation 230 of controlling the memory module so that a command received while the PIM computation command signal is being generated is processed through a PIM computation. For example, the in-memory computation may be processed using the PIM computation in response to the PIM computation command signal.

The operation 230 of controlling the memory module may include controlling the memory module so that a read command or a write command received while the PIM computation command signal is being generated are processed through a PIM computation. For example, a read command or a write command received when the value of the PIM computation command signal is 1 may be processed through a PIM computation.

When a PIM computation command signal corresponding to a specific group is generated, a corresponding read command or a corresponding write command received in accordance with a bank corresponding to the group may be processed using a PIM computation.

The method of controlling the memory module for the in-memory computation may include controlling the memory module so that a command received in a state in which generation of the PIM computation command signal has stopped may be processed using a general memory operation. For example, stopping generation of the PIM computation command signal may indicate setting the value of the PIM computation command signal to “0.” A read command or a write command received after generation of the PIM computation command signal has stopped may be processed using a general memory operation. In other words, when an address and a read command are received for a general memory operation, the memory module may output data stored in a memory cell indicated by the address to a host. When an address and a write command are received for the general memory operation, the memory module may store data received from the host in a memory cell indicated by the address.

The method of controlling the memory module for the in-memory computation may include stopping generation of a PIM computation command signal based on receipt of a precharge command. When the precharge command is received, the value of the PIM computation command signal may be changed to “0.” A read command or a write command received after the value of the PIM computation command signal is changed to “0” may be processed using a general memory operation.

The method of controlling the memory module for the in-memory computation may include initializing, based on receipt of the precharge command, the RCD count value stored in the register in accordance with the PIM computation bank of the address corresponding to the precharge command. When a precharge command is received, the RCD count value stored in the register in accordance with the PIM computation bank of the address corresponding to the precharge command may be initialized to a value (e.g., a number of clock cycles) indicating the time until a PIM row of the PIM computation bank is opened after an activation command ACT corresponding to an address of the PIM computation bank is processed. The RCD count value stored in the register in accordance with each of the PIM computation banks may be changed when an activation operation corresponding to a PIM computation bank is received.

The precharge command may initialize an RCD count value stored in the register in accordance with each of a plurality of PIM computation banks. For example, when a precharge command corresponding to an address of a first bank is received, not only an RCD count value stored in the register in accordance with the first bank but also an RCD count value stored in the register in accordance with a second bank may be initialized. For example, the RCD count values of more than one PIM computation bank may be initialized in response to receiving a single precharge command.

The method of controlling the memory module for the in-memory computation may include initializing, based on receipt of a precharge-all command, the RCD count value stored in the register in accordance with each of all the PIM computation banks included in the memory module. When a precharge-all command is received, an RCD count value stored in the register in accordance with each of all the PIM computation banks included in the memory module may be initialized to a value (e.g., the number of clock cycles) indicating the time from when an activation command ACT corresponding to an address of a PIM computation bank is processed until a PIM row of the PIM computation bank is opened.

The method of controlling the memory module for the in-memory computation may include stopping generation of a PIM computation command signal based on whether a number of times that PIM computations are performed in the memory module reaches a threshold number. The threshold number may be predetermined as a number of times that PIM computations need to be processed in the memory module and may be stored in the register. For example, whether the number of times that PIM computations are performed in the memory module has reached the threshold number may be determined by recording the number of times that PIM computations are to be performed in the memory module and comparing the number with the threshold number stored in the register. For example, the number of times that PIM computations need to be processed in the memory module stored in the register may be configured to decrease by “1” each time a PIM computation is performed in the memory module and, when the value of the number of times that PIM computations need to be processed in the memory module reaches “0,” the number of times that PIM computations are performed in the memory module may be determined to have reached the threshold number.

The method of controlling the memory module for the in-memory computation may include storing the number of times that PIM computations need to be processed in the memory module.

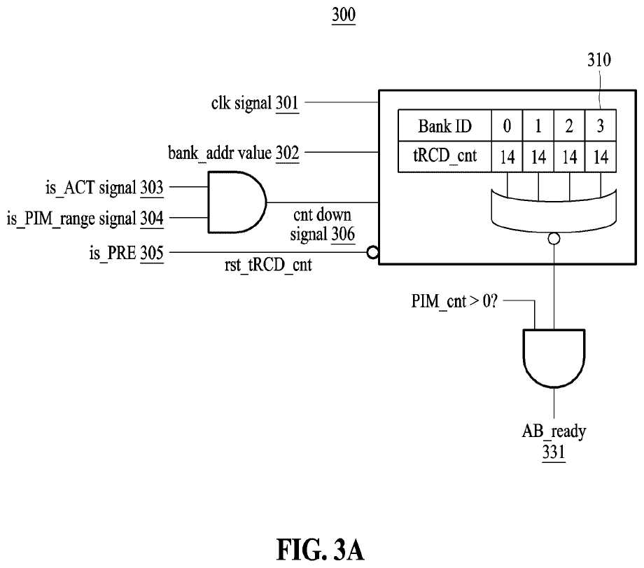

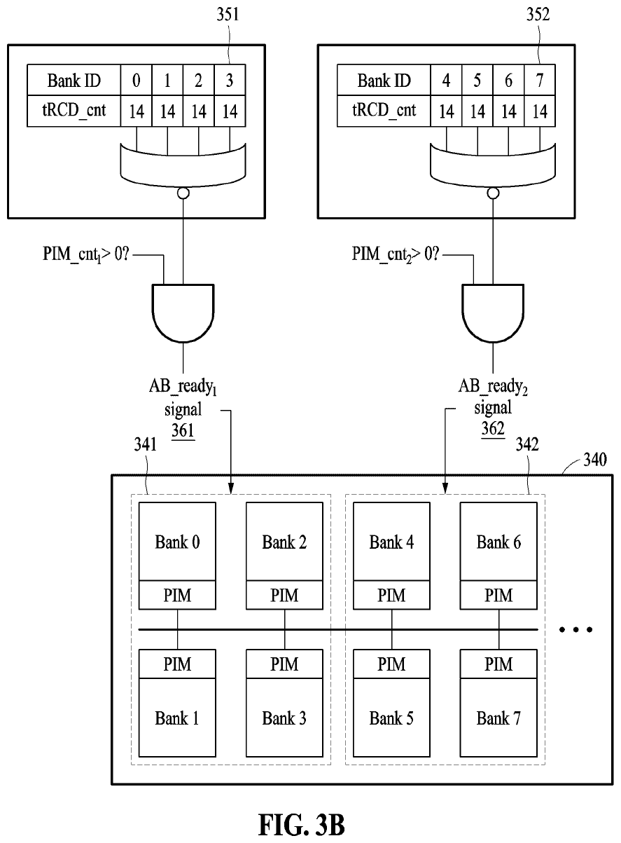

FIGS. 3A and 3B are diagrams illustrating structures of a PIM computation command signal generation circuit, according to an embodiment.

A PIM computation command signal generation circuit 300 shown in FIG. 3A may be included in the PIM control device 120 of FIG. 1. The PIM computation command signal generation circuit 300 generates an AB_ready signal 331, which is a PIM computation command signal, based on data stored in a PIM control device (e.g., 120). The PIM computation command signal generation circuit 300 includes a register 310 that stores an RCD count value tRCD_cnt corresponding to each PIM computation bank. For example, when four PIM computation banks are provided, an RCD count value of each of the four PIM computation banks may be stored in the register 310.

The PIM computation command signal generation circuit 300 may change the RCD count value corresponding to each PIM computation bank stored in the register 310, in response to processing of an activation command targeting a PIM computation bank. For example, the PIM computation command signal generation circuit 300 may receive an is_ACT signal 303 indicating whether a received command is an activation signal and an is_PIM_range signal 304 indicating whether a received address is within a PIM operator address range. For example, the value of the is_ACT signal 303 may be “1” when the received command is an activation signal and “0” when the received command is not an activation signal. For example, the is_PIM_range signal 304 may “e” “1” when the address received as the target of the activation command is within the PIM operator address range a“d” “0” when the address received as the target of the activation command is not within the PIM operator address range or outside the PIM operator address range.

The PIM computation command signal generation circuit 300 may generate a cnt down signal 306 indicating whether to change an RCD count value corresponding to a PIM computation bank stored in the register 310, based on the is_ACT signal 303 and the is_PIM_range signal 304. For example, the PIM computation command signal generation circuit 300 may generate the cnt down signal 306 with a value of “1” when the is_ACT signal 303 is “1” and the is_PIM_range signal 304 is “1” and may generate the cnt down signal 306 with a value of “0” when the is_ACT signal 303 is “0” or the is_PIM_range signal 304 is “0.”

When the cnt down signal 306 with a value of “1” is generated, the RCD count value stored in the register 310 in accordance with a PIM computation bank that is the target of the received activation command may decrease by “1” for every clock cycle. The clock cycle may be determined based on a clk signal 301. For example, the clock cycle may correspond to the time taken for the clk signal 301 to change from “0” to “1.” The PIM computation bank that is the target of the received activation command may be determined by a received bank address value, bank_addr value 302.

When all RCD count values stored in the register 310 become “0,” PIM rows of all PIM computation banks may be determined to be in an open state. When the PIM rows of all PIM computation banks are in an open state and a PIM_cnt value indicating the number of times that PIM computations need to be processed is greater than “0” (PIM_cnt>0), the PIM computation command signal generation circuit 300 may output the AB_ready signal 331 having a value of “1.”

As described above, monitoring and generation of a PIM computation command signal may be performed for each group of PIM computation banks. For example, referring to FIG. 3B, the PIM computation banks may include a PIM computation bank included in a first group 341 and a PIM computation bank included in a second group 342. Four PIM computation banks corresponding to Bank ID 0 to Bank ID 3 may be included in the first group 341. Four PIM computation banks corresponding to Bank ID 4 to Bank ID 7 may be included in the second group 342.

For example, the RCD count value (tRCD_cnt) of each of the four PIM computation banks included in the first group 341 may be stored in a first register 351. The RCD count value (tRCD_cnt) of each of the four PIM computation banks included in the second group 342 may be stored in a second register 352.

A PIM computation command signal generation circuit may change an RCD count value corresponding to each PIM computation bank stored in the first register 351, in response to processing of an activation command targeting a PIM computation bank included in the first group 341. When an activation command targeting a PIM computation bank included in the first group 341 is received, an RCD count value stored in the first register 351 in accordance with a PIM computation bank that is included in the first group 341 and is the target of the received activation command may decrease by “1” for every clock cycle.

The PIM computation command signal generation circuit may change an RCD count value corresponding to each PIM computation bank stored in the second register 352, in response to processing of an activation command targeting a PIM computation bank included in the second group 342. When an activation command targeting a PIM computation bank included in the second group 342 is received, an RCD count value stored in the second register 352 in accordance with a PIM computation bank that is included in the second group 342 and is the target of the received activation command may decrease by “1” for every clock cycle.

When all RCD count values stored in the first register 351 become “0,” PIM rows of all PIM computation banks included in the first group 341 may be determined to be in an open state. When the PIM rows of all the PIM computation banks included in the first group 341 are in an open state and a PIM_cnt₁ value indicating the number of times that PIM computations need to be processed in the first group 341 is greater than “0” (PIM_cnt₁>0), the PIM computation command signal generation circuit may output an AB_ready₁ signal 361 having a value of “1.” When the AB_ready₁ signal 361 having a value of “1” is input to a memory module 340, a CMD that is a read command or a write command received targeting a PIM computation bank included in the first group 341 may be processed using a PIM computation in response to the AB_ready₁ signal 361, and the PIM_cnt₁ value corresponding to the first group 341 may decrease by “1.”

When all RCD count values stored in the second register 352 become “0,” PIM rows of all PIM computation banks included in the second group 342 may be determined to be in an open state. When the PIM rows of all the PIM computation banks included in the second group 342 are in an open state and a PIM_cnt₂ value indicating the number of times that PIM computations need to be processed in the second group 342 is greater than “0” (PIM_cnt₂>0), the PIM computation command signal generation circuit may output an AB_ready₂ signal 362 having a value of “1.” When the AB_ready₂ signal 362 having a value of “1” is input to the memory module 340, a CMD that is a read command or a write command received targeting a PIM computation bank included in the second group 342 may be processed using a PIM computation in response to the AB_ready₂ signal 362, and the PIM_cnt₂ value corresponding to the second group 342 may decrease by “1.”

When the AB_ready₁ signal 361 is 1 and the AB_ready₂ signal 362 is 0, a read command or a write command received targeting a PIM computation bank included in the first group 341 may be processed using a PIM computation, and a read command or a write command received targeting a PIM computation bank included in the second group 342 may be processed using a general memory operation. When the AB_ready₁ signal 361 is 0 and the AB_ready₂ signal 362 is 1, a read command or a write command received targeting a PIM computation bank included in the first group 341 may be processed using a general memory operation, and a read command or a write command received targeting a PIM computation bank included in the second group 342 may be processed using a PIM computation.

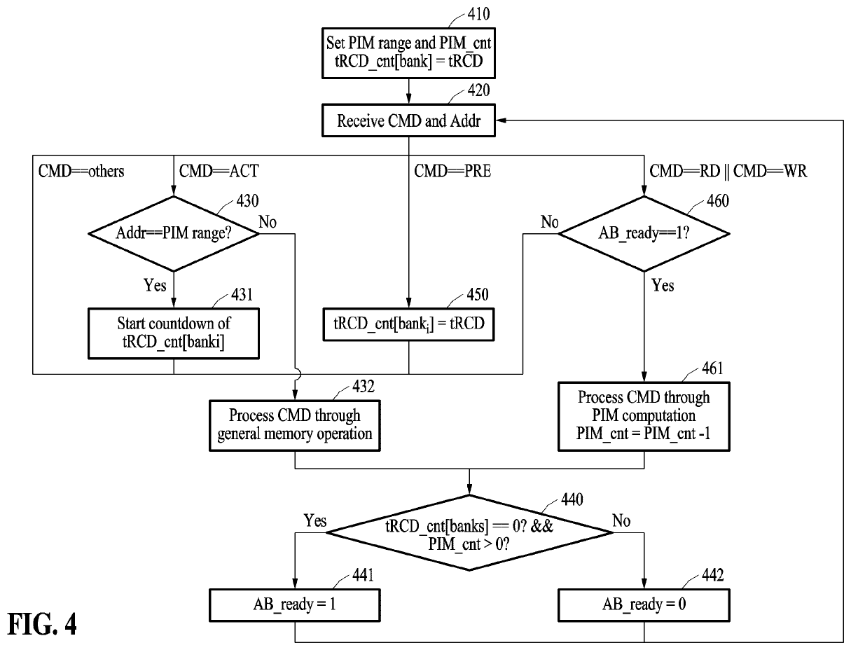

FIG. 4 is a flowchart illustrating an operation of a memory device according to an embodiment.

For example, a memory device may include a PIM control device and a memory module controlled by the PIM control device. The PIM control device may correspond to the PIM control device 120 of FIG. 1, and the memory module may correspond to the memory module 130 of FIG. 1.

Referring to FIG. 4, in operation 410, the PIM control device sets a PIM operator address range PIM range and a value of a number of times PIM_cnt that PIM computations need to be processed in a register and sets (or stores) an RCD count value corresponding to a PIM computation bank to a value indicating the time tRCD until a PIM row of the PIM computation bank is opened after an activation command corresponding to an address of the PIM computation bank is processed. For example, the PIM_cnt value may be set to a value input by a user. The tRCD value may be determined based on the specifications of the memory module.

In operation 420, the PIM control device receives a command CMD and an address Addr. When the received command is an activation command (CMD==ACT), the PIM control device determine whether the received address is within the PIM operator address range in operation 430.

When the received address is determined not to be in the PIM operator address range (Addr=/=PIM range), the CMD is processed using a general memory operation in operation 432. The PIM control device may control the memory module so that the received CMD may be processed using the general memory operation.

When the received address is determined to be within the PIM operator address range (Addr==PIM range), a countdown of the RCD count value tRCD_cnt[bankᵢ] corresponding to the PIM computation bank bank; corresponding to the received address is started in operation 431. The countdown of the RCD count value tRCD_cnt[bankᵢ] corresponding to the PIM computation bank (bankᵢ) in operation 431 may refer to reducing the RCD count value tRCD_cnt[bankᵢ], which is stored in the register, corresponding to the PIM computation bank bankᵢ by “1” for every clock cycle. The countdown may start in operation 431, and the CMD that is an activation command is processed using a general memory operation in operation 432.

In operation 440, the PIM control device determines whether an RCD count value tRCD_cnt[banks], which is stored in the register, corresponding to all PIM computation banks banks is “0” and whether the PIM_cnt value is greater than “0.” It may be determined whether each RCD count value, which is stored in the register, corresponding to all the PIM computation banks banks is “0.” For example, in the case that the PIM computation bank includes bank1, bank2, and bank3, when tRCD_cnt[bank1], tRCD_cnt[bank2], and tRCD_cnt[bank3] are all 0, it may be determined that the RCD count value tRCD_cnt[banks], which is stored in the register, corresponding to all the PIM computation banks (banks) is “0.”

When it is determined that the RCD count value tRCD_cnt[banks], which is stored in the register, corresponding to all the PIM computation banks banks is “0” and the PIM_cnt value is greater than “0,” an AB_ready signal, which is a PIM computation command signal, is set to “1” in operation 441. When it is determined that the RCD count value tRCD_cnt[banks], which is stored in the register, corresponding to all the PIM computation banks banks is not “0” or the PIM_cnt value is “0,” the AB_ready signal is set to “0” in operation 442.

When the received command is a precharge command (CMD==PRE), the RCD count value tRCD_cnt[bankᵢ] corresponding to the PIM computation bank bankᵢ corresponding to the received address is set (or initialized) to tRCD in operation 450. A CMD that is a precharge command is processed 432 using a general memory operation. In operation 440, it may be determined whether the RCD count value tRCD_cnt[banks], which is stored in the register, corresponding to all the PIM computation banks (banks) is “0” and whether the PIM_cnt value is greater than “0.” Since the RCD count value tRCD_cnt[bankᵢ] corresponding to the PIM computation bank bankᵢ corresponding to the received address is set to tRCD in operation 450, the RCD count value tRCD_cnt[banks] corresponding to all the PIM computation banks banks may be determined to be non-zero. Thus, in operation 442, the AB_ready signal is set to “0.”

When the received command is a read command or a write command (CMD==RD or CMD==WR), the PIM control device determines 460 whether the AB_ready signal is “1.”

When the AB_ready signal is 1, a CMD that is a read command or a write command is processed using a PIM computation, and the PIM_cnt value is decreased by “1” in operation 461. For example, the PIM control device may control the memory module so that the received CMD is processed through a PIM computation. The PIM control device may change the PIM_cnt value stored in the register to a value 1 less than the current value and store the changed PIM_cnt value. When the changed PIM_cnt value is “0,” the AB_ready signal is set to “0” in operation 442 by the determination made in operation 440.

When the received command is a command (CMD==others) other than an activation command, a precharge command, a read command, or a write command, the CMD is processed 432 using a general memory operation. For example, a command other than an activation command, a precharge command, a read command, and a write command may be a refresh REF command. For example, the refresh REF command may be used to refresh one or more memory banks.

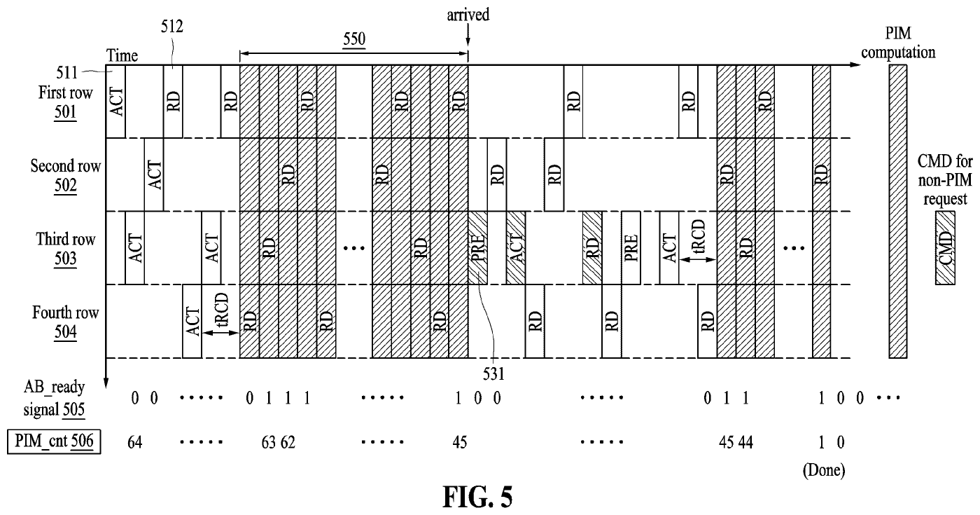

FIG. 5 is a diagram illustrating a command processed in a PIM computation bank, according to an embodiment.

Referring to FIG. 5, each row may correspond to each PIM computation bank. A first row 501, a second row 502, a third row 503, and a fourth row 504 show commands processed in a first bank, a second bank, a third bank, and a fourth bank, respectively, which are all PIM computation banks, in order of time.

Referring to the first row 501, an activation command ACT 511 targeting the first bank is received, and a countdown of an RCD count value corresponding to the first bank may begin to monitor an open state of a PIM row of the first bank. When the RCD count value corresponding to the first bank becomes “0,” the PIM row of the first bank may be determined to be in an open state. Even when the RCD count value corresponding to the first bank becomes “0,” when an RCD count value corresponding to another bank is not “0,” a read command 512 received corresponding to the first bank may be processed using a general memory operation.

An activation command targeting a corresponding bank may be received in the order of the first bank, the third bank, the second bank, and the fourth bank. When a time (tRCD) until a PIM row of a PIM computation bank is opened after an activation command 541 corresponding to the fourth bank is processed, RCD count values of all PIM computation banks may become “0.” Thus, PIM rows of all PIM computation banks may be determined to be in an open state. When the RCD count values of all PIM computation banks become “0,” a value of an AB_ready signal 505, which is a PIM computation command signal, may be changed from “0” to “1.”

A read command (or a write command) received during a period 550 in which the AB_ready signal 505 value is “1” may be processed using a PIM computation. When one command is processed using a PIM computation, the number of times PIM_cnt 506 that PIM computations need to be processed may be reduced by “1.” For example, the number of times PIM_cnt 506 that PIM computations need to be processed may be set to a predetermined value, for example, “64.” For example, when 19 read or write commands are processed using a PIM computation, the PIM_cnt 506 may decrease by “1” from “64” and be changed to “45”.

Referring to the third row 503, when a precharge command 531 corresponding to the third bank is received, an RCD count value corresponding to the third bank may be initialized to the value of the tRCD. The AB_ready signal 505 value may be changed to “0.” A command received while the AB_ready signal 505 value is “0” may be processed using a general memory operation. When a command is processed using the general or a normal memory operation, the value of the PIM_cnt 506 does not change. For example, the value of the PIM_cnt 506 remains constant when the command is processed using the normal memory operation.

When the value of the PIM_cnt 506 value becomes “0,” the AB_ready signal 505 may be changed to “0” so that the received command is not processed using a PIM computation. A command received while the AB_ready signal 505 value is “0” may be processed using the normal memory operation.

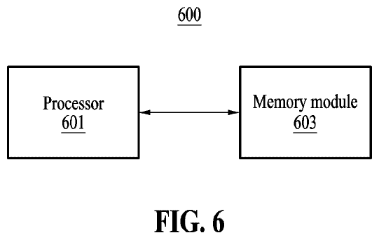

FIG. 6 is a diagram illustrating a configuration of a memory device for an in-memory computation, according to an embodiment.

Referring to FIG. 6, a memory device 600 may include a processor 601 and a memory module 603. The memory device 600 may include a PIM control device (e.g., the PIM control device 120 of FIG. 1) described above with reference to FIGS. 1 to 5. The memory module 603 of the memory device 600 may correspond to the memory module 130 of FIG. 1.

The processor 601 or a logic circuit may perform at least one operation related to the method of controlling the memory module 603 for an in-memory computation described above with reference to FIGS. 1 to 5. The processor 601 may correspond to the PIM control device 120 of FIG. 1. For example, the processor 601 may include at least one processor of the PIM control device 120 of FIG. 1. For example, the processor 601 may perform at least one of monitoring, based on a command and an address received from a memory controller, an open state of a PIM row of a PIM computation bank in the memory module 603 corresponding to the address, generating a PIM computation command signal (or an AB_ready signal) when it is determined as a result of the monitoring that a PIM row of each of PIM computation banks included in the memory module 603 is in an open state, or controlling the memory module 603 so that a command received while a PIM computation command signal is being generated may be processed through a PIM computation.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, the processing device may include multiple processing elements and/or multiple types of processing elements. For example, the processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be those available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules to perform the operations of the above-described examples, or vice versa.

Although the examples have been described with reference to certain drawings, various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A method of controlling a memory module for a processing in-memory (PIM) computation, the method comprising:
monitoring, based on a first command and an address, an open state of a PIM row of a PIM computation bank in the memory module corresponding to the address;
generating a PIM computation command signal when it is determined as a result of the monitoring that a PIM row of each of PIM computation banks included in the memory module is in the open state; and
controlling the memory module so that a second command received while the PIM computation command signal is generated is processed using a PIM computation.

2. The method of claim 1, wherein the monitoring of the open state comprises:
monitoring the open state of the PIM row of the PIM computation bank in the memory module corresponding to the address when the first command is an activation command and the address is within a PIM operator address range.

3. The method of claim 1, wherein the monitoring of the open state comprises:
updating a count value stored in a register in accordance with the PIM computation bank for every clock cycle; and
determining that the PIM row of the PIM computation bank in the memory module corresponding to the address is in the open state, based on the count value.

4. The method of claim 3, further comprising setting the count value corresponding to a first PIM computation bank to a value indicating a time until a PIM row of the first PIM computation bank is opened after an activation command corresponding to an address of the first PIM computation bank is processed.

5. The method of claim 1, further comprising:
storing a number of times that PIM computations need to be processed in the memory module,
wherein the second command is processed using the PIM computation when the number of times is non-zero.

6. The method of claim 1, further comprising:
stopping generation of the PIM computation command signal based on whether a number of times a PIM computation is performed in the memory module reaches a threshold number.

7. The method of claim 1, wherein the controlling of the memory module comprises:
controlling the memory module so that a read command or a write command received while the PIM computation command signal is generated is processed using a PIM computation.

8. The method of claim 1, further comprising:
stopping generation of the PIM computation command signal based on receipt of a precharge command.

9. The method of claim 8, further comprising:
initializing, based on receipt of the precharge command, the count value corresponding with a PIM computation bank of an address corresponding to the precharge command.

10. The method of claim 1, further comprising:
controlling the memory module so that a command received after stopping generation of the PIM computation command signal is processed using a normal memory operation.

11. The method of claim 1, wherein
the PIM computation banks in the memory module are classified into groups comprising a first group and a second group,
the generating of the PIM computation command signal comprises generating a PIM computation command signal corresponding to the first group when it is determined as a result of the monitoring that a PIM row of each of PIM computation banks included in the first group is in an open state, and
the controlling of the memory module comprises controlling the memory module so that a command received corresponding to a PIM computation bank included in the first group is processed using a PIM computation.

12. A non-transitory computer-readable storage medium storing instructions that, when executed by a processor, cause the processor to perform the method of claim 1.

13. A memory device for performing a processing in-memory (PIM) computation, the memory device comprising:
a memory module comprising at least one of a plurality of PIM computation banks; and
a processor configured to control the memory module,
wherein the processor is configured to:
monitor, based on a first command and an address, an open state of a PIM row of one of the PIM computation banks in the memory module corresponding to the address;
generate a PIM computation command signal when it is determined as a result of the monitor that a PIM row of each of the PIM computation banks is in the open state; and
control the memory module so that a second command received while the PIM computation command signal is generated is processed using a PIM computation.

14. The memory device of claim 13, wherein, in the monitor of the open state, the processor is configured to:
monitor the open state of the PIM row of the PIM computation bank in the memory module corresponding to the address when a received command is an activation command and the address is within a PIM operator address range.

15. The memory device of claim 13, wherein, in the monitor of the open state, the processor is configured to:
update a count value stored in a register in accordance with the PIM computation bank for every clock cycle; and
determine that the PIM row of the PIM computation bank in the memory module corresponding to the address is in an open state, based on the count value.

16. The memory device of claim 13, wherein the processor is configured to:
store a number of times that PIM computations need to be processed in the memory module,
wherein the second command is processed using the PIM computation when the number of times is non-zero.

17. The memory device of claim 13, wherein the processor is configured to:
stop generation of the PIM computation command signal based on whether a number of times a PIM computation is performed in the memory module reaches a threshold number.

18. The memory device of claim 13, wherein, in the control of the memory module, the processor is configured to:
control the memory module so that a read command or a write command received while the PIM computation command signal is generated is processed using a PIM computation.

19. The memory device of claim 13, wherein the processor is configured to:
stop generation of the PIM computation command signal based on receipt of a precharge command;
initialize, based on receipt of the precharge command, a count value stored in a register in accordance with a PIM computation bank of an address corresponding to the precharge command; and
control the memory module so that a command received after stopping generation of the PIM computation command signal is processed using a normal memory operation.

20. A device for controlling a memory module to perform a processing in-memory (PIM) computation, comprising:
a processor configured to:
monitor, based on a command and an address, an open state of a PIM row of a PIM computation bank in the memory module corresponding to the address;
generate a PIM computation command signal when it is determined as a result of the monitor that a PIM row of each of PIM computation banks included in the memory module is in an open state; and
control the memory module so that a command received while the PIM computation command signal is generated is processed using a PIM computation.
